(19) United States
(12) Patent Application Publication
(10) Pub. No.: US 2024/0073165 A1
(43) Pub. Date: Feb. 29, 2024

(54) SYSTEMS METHODS FOR ADMINISTERING A USER APPLICATION USING AN EMAIL PLATFORM

(71) Applicant: InspireHUB Inc., Dallas, TX (US)

(72) Inventors: Daniel Plarina, LaSalle (CA); Darren Withers, Los Angeles, CA (US); Karolyn Hart, Lakeshore (CA)

(21) Appl. No.: 18/365,866

(22) Filed: Aug. 4, 2023

Related U.S. Application Data
(60) Provisional application No. 63/400,311, filed on Aug. 23, 2022.

(51) Int. Cl. H04L 51/066; G06F 40/14; G06F 40/186; H04L 51/08

(52) U.S. Cl. CPC H04L 51/066; G06F 40/14; G06F 40/186; H04L 51/08

(57) ABSTRACT

Systems and methods for administering a user application using an email platform involve causing a user application to be stored on a user device, the user application including a plurality of pages, each page having one or more sections configured to be populated by a pre-formatted email file, where each section is assigned a unique email address; associating a pre-formatted email file with each unique email address of the user application, which pre-formatted email file also has the corresponding unique email address assigned thereto. The pre-formatted email file is configured by HTML content or a template and displayed as content in the section of the user application having the correspondingly assigned unique email address. The pre-formatted email file is updated, optionally with variable content, and transmitted to the corresponding section of the application having the matching email address and displayed on a user interface of the user device.

### CROSS-REFERENCE TO RELATED APPLICATIONS

This application claims priority to U.S. Provisional Patent Application No. 63/400,311, filed Aug. 23, 2022, entitled “SYSTEMS METHODS FOR ADMINISTERING A USER APPLICATION USING AN EMAIL PLATFORM,” which is incorporated by reference herein, in the entirety and for all purposes.

### TECHNICAL FIELD

Methods and systems administer user applications, such as progressive web applications for handheld devices, using an email platform.

### BACKGROUND

Many mobile platforms such as native applications for mobile loyalty solutions are robust, requiring significant time and cost to develop and launch. For instance, mobile loyalty solutions within the casino industry can cost anywhere from $100,000 to $250,000 to develop in the first year and typically have a recurring monthly or annual cost. In addition, integration into the casino management systems are dependent upon the internal IT complexities and/or administrative certification hurdles that differ among states.

### SUMMARY

Implementations provide computer-implemented methods for administering a user application using an email platform, involving the steps of: Providing a user application including plurality of pages, each page having one or more sections configured to be populated by a pre-formatted email file, where each section is assigned a unique email address. Storing the application on a user device, where the application is communicatively coupled to an email server including an email platform. Associating a pre-formatted email file with each unique email address, the pre-formatted email file configured as a template and configured to be displayed as content in the section of the application having the corresponding assigned unique email address. Storing the HTML email files in the email server. Transmitting the pre-formatted email files to the section of the application having the email address corresponding to the pre-formatted email file. Displaying the transmitted pre-formatted email file on a user interface of the user device. Receiving from the email platform of the email server, updated pre-formatted email files for the unique email addresses, the updated pre-formatted email files containing updated pre-formatted content. Transmitting the updated pre-formatted email files to the application for populating in the corresponding section of the application for display on the user interface.

In various implementations and alternatives, the user device is associated with a user, and the user is assigned a unique user email address, which is associated with one of the plurality of pages of the user application. The pre-formatted email assigned the unique user email address is configured to receive content associated with the user including two or more of a user name, a user identification, user statistics, user rewards, and user-specific information. In such implementations and alternatives, another of the plurality of pages of the user application may be associated with promotional content, which is delivered to a plurality of users of a plurality of user applications stored on a plurality of user devices. In such implementations and alternatives, the one of the plurality of pages and the another plurality of pages are each configured as read only pages, e.g., depending on user permissions.

Further implementations provide methods for administering a user application using an email platform, involving the steps of: Causing a user application to be stored on a user device, the user application including a plurality of pages, each page having one or more sections configured to be populated by a pre-formatted email file, where each section is assigned a unique email address. Associating a pre-formatted email file with each unique email address of the user application, the pre-formatted email file including the unique email address corresponding to a respective section of the user application, and the pre-formatted email file configured as a template and configured to be displayed as content in the section of the user application having the correspondingly assigned unique email address. Causing the pre-formatted email files to be transmitted to the corresponding section of the application having the email address corresponding to the pre-formatted email file. Causing the transmitted pre-formatted email file to be displayed on a user interface of the user device.

In various implementations and alternatives, the user device is associated with a user, and the user is assigned a unique user email address, where the unique user email address is associated with one of the plurality of pages of the user application, and where the pre-formatted email assigned the unique user email address is configured to receive content associated with the user including two or more of a user name, a user identification, user statistics, user rewards, and user-specific information. In various implementations and alternatives, prior to causing the pre-formatted email files to be transmitted to the corresponding section of the application having the email address corresponding to the pre-formatted email file, the method further involves determining a format of the corresponding section of the user application, and adjusting the pre-formatted email to the determined format. In such implementations and alternatives, the step of causing the transmitted pre-formatted email file to be displayed on a user interface of the user device further involves causing the adjusted pre-formatted email to be displayed on the user interface.

In various implementations and alternatives, prior to causing the pre-formatted email files to be transmitted to the corresponding section of the application having the email address corresponding to the pre-formatted email file, the method involves evaluating the pre-formatted email file using a content management system, where evaluating includes two or more of: identifying and removing a signature with the pre-formatted email file; identifying and removing an unsubscribe link from the pre-formatted email file; identifying and removing tracking pixels from the pre-formatted email file; identifying a table and freezing the table within the pre-formatted email file; identifying an image and fitting the image within the template or content; and identifying a table and fitting the table to an identified format of the corresponding section of the user application.

In various implementations and alternatives, prior to causing the pre-formatted email files to be transmitted to the corresponding section of the application having the email address corresponding to the pre-formatted email file, the method may involve evaluating the pre-formatted email file using a content management system, to determine a domain from which the pre-formatted email file was transmitted is contained in an approved sender list.

The user application may a progressive web application (PWA) or a native application, may be a read only application, e.g., depending on user permissions. The pre-formatted email file may be a HTML email file.

In various implementations and alternatives, the method may further involve causing updated pre-formatted email files to be received at the user device that contain updated content; and causing the updated pre-formatted email files to be displayed on a user interface of the user device.

Yet further implementations provide systems for administering user applications installed on handheld devices registered to a plurality of users using an email platform, the system including: A server storing a plurality of user accounts, each user account associated with a registered user application of the user applications and an email address unique to each user account, where each email address unique to each user account is associated with a first page of a plurality of pages of the registered user application and is associated with a first template configured for delivery by an email platform to the first page of the user application of the registered user application such that first templates configured for delivery by the email platform to the first pages of the registered user applications contain different content across the plurality of user accounts, where the user application includes a second plurality of pages, and where the second plurality of pages of the user application are each associated with an email address that is different from each other, and where the registered user applications of the plurality of user accounts each include the same second plurality of pages of the user application having the same associated email addresses such that second templates configured for delivery by the email platform to the second plurality of pages of the registered user applications contain the same content across the plurality of user accounts.

In various implementations and alternatives, the system further includes a content management system configured to receive the first and second templates configured for delivery by the email platform and to transmit the first and second templates to a corresponding page of the user application as templated content, where prior to transmitting to the user application, the content management system determines a format of a corresponding section of the user application and adjusts the templated content to the determined format. In addition or alternatively, the content management system may be configured to receive the first and second templates configured for delivery by the email platform and to transmit the first and second templates to a corresponding page of the user application as templated content, where prior to transmitting to the user application, the content management system performs two or more of the steps of: identifying and removing a signature with the pre-formatted email file; identifying and removing an unsubscribe link from the pre-formatted email file; identifying and removing tracking pixels from the pre-formatted email file; identifying a table and freezing the table within the pre-formatted email file; identifying an image and fitting the image within the template or content; and identifying a table and fitting the table to an identified format of the corresponding section of the user application.

### BRIEF DESCRIPTION OF THE DRAWINGS

FIG. 1 illustrates a diagram of a network that may be used in connection with the disclosed system for deploying content over an email platform, according to the present disclosure;

FIG. 2 illustrates a method of administering user applications on handheld devices using an email platform, according to the present disclosure; and

FIG. 3 illustrates aspects of administering user applications on handheld devices using an email platform, according to the present disclosure.

### DETAILED DESCRIPTION

Implementations provide for the use of email systems in the practical application of administering a user application. The email system delivers static or variable content to a user application. The content created via templates has destinations that are arranged within the user application based on unique identifiers associated with a field or fields of the user application corresponding to email content. Rather than implementing an email system for enabling communications between the user and the administrator of the email, or between users, the implementations of the present disclosure use the email system in a manner that permits the user to view the updated content as controlled by the administrator, while the user is prevented from interacting with the email system, for instance from interacting with the administrator or other users of the email system. For example, the user may be prevented from responding to the email content via the user application. The approach is an improvement over prior approaches where users receive emails directly that may need to be recalled and resent, which requires a significant amount of network bandwidth. In contrast, as provided herein, a single email template with updated content may be delivered to a group of user applications, such as to user applications of all users registered in the system, which reduces network operations as the user applications receive the same content across all users, which may be accessed by the user upon access of their user application.

User applications (e.g., a progressive web application (PWA) or a native application) are deployed for handheld or other computer devices, where all or a portion of the user application may be “read only”, which enables streamlined delivery of variable content via email systems, resulting in content deployment at a fraction of the cost compared to prior approaches. The present disclosure may apply to a broad array of user applications that may benefit from streamlined administration of variable content (e.g., personalized content and/or real-time content) using email systems as provided herein and the user applications may include but are not limited to gaming and loyalty programs, and computer applications in industries that are regulated which use an email system instead of a direct connection to data containing private data, e.g., personally identifiable information, such as the payment card and healthcare industries.

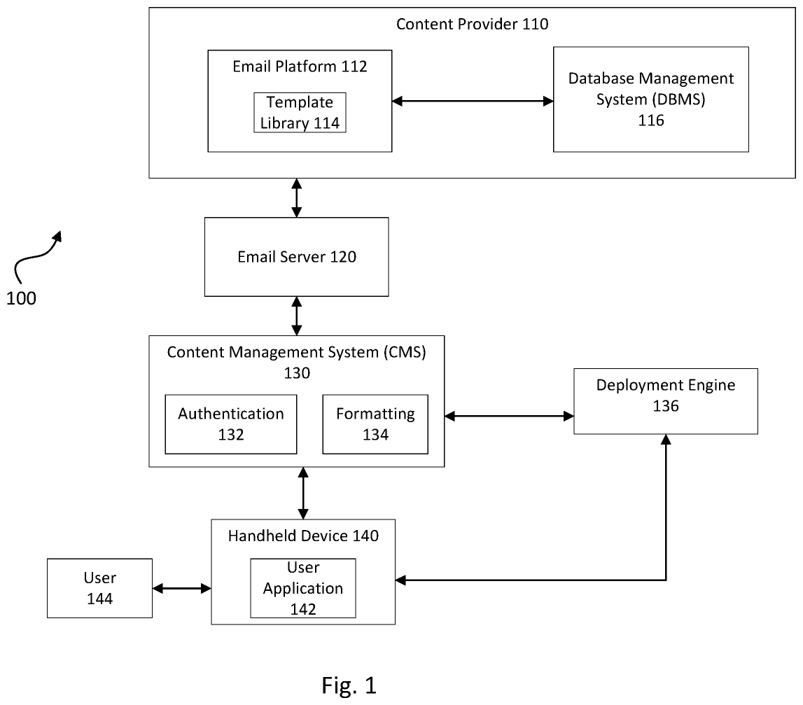

Turning to FIG. 1, illustrated is a diagram of a computer network 100 that may be used in connection with the systems and methods for deploying content over an email platform, according to the present disclosure. The network 100 may include a content provider 110 including an email platform 112 having a template library 114 and a database management system 116; an email server 120; a content management system (CMS) 130 with authentication 132 and formatting 134 modules; a deployment engine 136; and handheld devices 140 with user applications 142 for use by a user 144.

The content provider 110 may provide marketing, advertising and user-specific content for a business such as a casino or gaming organization. According to the present disclosure, the content provider 110 may manage and distribute emails from a template library 114 of the email platform 112. The template library 114 may include a variety of templates configured to be deployed over the network 100, which may ultimately be displayed on a plurality of handheld devices 140 via the user applications 142. In some implementations, the templates of the template library 114 are combined with user data within the email platform to produce a complete email for the intended recipient that will be received by the email server, and in turn be provided to the CMS for delivery to a corresponding page in the user application having a matching email address.

According to certain implementations, the pages of the CMS corresponding to each user within the user application may be populated automatically by importing user data in the form of a CSV from the email platform 112 or some other user database, and in turn generating a corresponding email address for the page within the user application 142. The emails may be configured as pre-formatted email files containing headers or other HTML elements, at least a portion of which is adapted for display as content on a handheld device in a section or page of a user application having a matching unique email address. The templates within the email platform may be configured for each of a plurality of pre-defined sections or pages of the user application 142 using headers or other HTML elements. For example, the email platform 112 of the content provider 110 may automatically cause updates to be provided to each page or section of the user application 140 by sending a bulk email, or other automated processes, that deliver content to the email platform 112 to trigger sending content to the user applications 142 over the network. For instance, after changes are made to the template a corresponding email sent using the revised template could be used to update an existing corresponding page within the user application. In one example, using a cloud-based email service provider, user data may be received by the platform on a daily basis using a data transfer process that contains profile data such as user account number, first name, last name, birthdate, etc. In the example of a casino or gaming authority, this would setup an ETL (Extraction, Transformation, and Loading) or SQL (Structured Query Language) process or stored procedure to extract the file of all active users (e.g., casino players) from for instance, a Casino Management System, CRM or Data Warehouse, and process the data into a flat file (CSV) to be picked up by the file transfer process. This may be a daily or higher frequency process (e.g., every hour). The templates of the present disclosure may be configured to trigger from the email service provider in an automation where the criteria for triggering a template is a change in the data or a recurring scheduled deployment. The criteria/filter/segment may be used to determine what template is deployed to each user and how often, refreshing the variable content displayed in each user's app instance.

Templates of the template library 114 may be configured within a pre-formatted electronic message, such as an email, an enriched text email, and other electronic message approaches that enable formatting and semantic markup. The user may be associated with a dedicated email address, which may correspond to a page or a section of the application 142 where the email composed from the template is to be deployed and displayed. For instance, each page of the user application 142 may be associated with one or more dedicated email addresses, where each email address of the user application 142 matches an email address of the corresponding page. The templates may include variable content along with static content, which may enable semantic markup capabilities. In addition or alternatively, sections of a page may be individual content blocks within the user application 142, and the section may be all or a portion of a scene on the page. In some implementations, pre-formatting relates to pre-formatted text size, text wrapping, font, image or other content sizing, and so on. Because the templates inform the configurable email files, they may be stored in the email platform 112 and transmitted over the network 100 to various servers and components of the network 100 based on the origin of the template and on the identifier of the template.

The email server 120 may be configured as an incoming and outgoing email server. According to the present disclosure, templates transmitted from the email platform 112 intended for the user application 142 may be flagged by the email server 120, provided to the CMS 130 for authentication, analysis and/or processing, and the CMS 130 causes the content or template to be delivered to a page or portion of the user application 142 having the matching email address. For instance, the email server 120 may send an alert to the CMS 130 that an incoming mail has content or a template requiring analysis and/or processing. The CMS 130, using the email address upon which the email is delivered to, or the HTML contained therein will determine the appropriate pages to update within the user application.

The CMS 130 processes the content or template in a manner that advantageously enables users to receive customized content on the user application 142 of their handheld device 140 without the need for complex mobile application platform development. CMS 130 is configured for validation, analysis and/or processing the emails and may include processing and rendering capabilities for modifying the content or template into a form adapted for receipt and display within the user application 142, and thus may be used as an administration tool. For instance, the CMS 130 may determine whether the content or template requires rendering or other processing to format the content or template for proper display on a handheld device 140 of the user 144 prior to delivery to the user application 142. The CMS 130 may adjust a frame or size of the content or template to ensure it will display properly within a respective pre-defined portion of the user application 142 having the corresponding email address associated therewith.

With reference to the authentication 132 and formatting 134 modules of the CMS 130, these modules may be applied to the emails before transmitting and/or populating their content into a corresponding section or page of the user applications 142. For instance, the authentication module 132 may be applied using DNS (Domain Name System) TXT record validation, or IP address whitelisting, and may permit only emails derived from certain domains or specific IP addresses. The authentication module 132 may also filter content within the emails and their templates to remove unwanted content such as malware or malicious code (e.g., action scripting, JavaScript, css, and/or iframes) to help avoid unauthorized access into the network 100. In another example, the authentication module 132 may analyze a header of the email to determine if the header contains authentication information that identifies the email and its template as being safe for processing by the CMS 130. The formatting module 134 may scrub content from the email and its template such as by: removing tracking pixels or forcing the pixels to be non-responsive to prevent the pixels from interfering with the layout of the template in its corresponding page or portion thereof; removing signature blocks and unsubscribe links and related information; extracting data of a pre-formatted email (e.g., HTML email), changing pre-formatted email into a post to display within the hub; for content including tables or images, styling such as self-spacing and borders may be overridden and/or the tables may be adjusted to ensure they fit within the width of the page of the user application 142 or portion thereof; for content derived from third parties adjusting the content for sizing and performing other formatting functions described herein; analyzing headers in the email to identify specific instructions for optimization, e.g., formatting, within the page or portion thereof; parse a multi-part email and causing portions of the email to be transmitted into the designated page or portions thereof.

Updating templates on a client side (e.g., content provider 110) and CMS 130 side may involve the following steps. A template is provided to the client to pre-load into their email system, e.g., email platform 112. This template is used to publish the design of a page or post into the hub, e.g., CMS 130. For example, the template may include: an image at top, body in middle and call to action at bottom. Content updates to the same post: Using the template, the customer will be able to send over changes to the content on the same page, instead of just creating a new duplicate page with the changed content. For the need to update the template, the customer may decide they want to change the template from “image at top, body in middle, call to action at bottom” to something else (for example). An identifier will be embedded that allows the changes to be made to the same page or post.

The CMS 130 may be compatible with a variety of email servers 120 such that third party-controlled inbound email systems may be used to administer and provide updates to the content of the user applications 142.

The deployment engine 136 may deliver user applications 142 to handheld devices 140 or to third party hosts where the user applications 142 may be downloaded by the users 144 to the handheld devices 140. In some implementations, the CMS 130 may be used to generate and deliver templated content, user applications or user application content to the deployment engine 136 for subsequent delivery over the network. In further implementations, the deployment engine 136 may be a component of the CMS 130.

The handheld devices 140 may be configured as mobile devices such as a mobile phone, tablet, laptop and so on, and may include one or more mobile applications that enable users to interact therewith, including the user application 142 of the present disclosure. Although the present disclosure refers to handheld devices 140 as being configured to store the applications of the present disclosure, the skilled artisan should not construe handheld devices as being limiting, and other computer devices containing a microprocessor, memory and communication devices for communicating the network 100 are devices within the scope of the present disclosure. For instance, kiosk tablets or computer stations may deploy the user applications 142 of the present disclosure.

The user applications 142 may be computer-implemented applications such as progressive web applications or a native applications. User applications may be mobile applications transmitted to a computer device such as a mobile device. According to certain implementations, all or a portion of the user application 142 may be configured as read only, such that the user may view but not enter information into the user application or portion thereof. For instance, one or more pages of the user application 142 may contain the templated content having a matching email address, which may read/viewed by the user, but the templated content within the user application 142 may not be configured to enable the user to enter information.

The user application 142 may have a plurality of pages configured to receive template content over the network 100. The pages may include one or more sections for receiving content from the network. According to the present disclosure, at least one of the pages or portion thereof (e.g., section) may contain customized content for the user. In addition to all or a portion of the content optionally being read only, certain pages or sections of the user application 142 associated with the email addresses may not include an email composing function, and for instance may be free of an editor for composing emails, and thus free of a graphical user interface for composing emails. In some implementations, a user interface may be provided for creating/updating the content displayed within the user application, for instance, a permission-based user interface may be provided for the user when registering or updating their profile.

The user application 142 may be transmitted to the handheld device 140 over the network 100, e.g., via the internet, over a wide area network, a local area network, using physical media, and so on. Upon instantiation, the user may navigate between pages of the user application 142 using one or more menu selections displayed in areas of the graphical user interface that is separate from the template-derived content.

In some implementations, the network 100 may be used to administer user applications 142 using the email platform 112 as follows. The content provider 110 may include a server storing a plurality of user accounts, where each user account is associated at least with: a page or pages within the user application 142 registered or assigned to the user 144 (e.g., a registered user application), and an email address unique to each user account, in combination with specific pages within the user application. The email address may also be unique to an individual (e.g., a person) and may have a standard format, e.g., suesmith@userapplication.com. The email address unique to each user account is associated with a first page (e.g., a user channel) or section of a plurality of pages or sections of the user application 142 of the user 144, and is also associated with a first template of the template library 114 within the email platform. The first template is configured for delivery by the unique email address to the portion or page of the user application 142 of the individual user, and the user application 142 is typically installed on a handheld device 140 that is registered to the user 144. Thus, content generated by the first templates delivered and displayed on the first pages of the registered user applications contain different content across the plurality of user accounts. For instance, the first page and corresponding first template may be populated with content specific to the unique user 144, and each unique user 144 may receive customized content. The first templates may be updated periodically (e.g., hourly, daily, weekly) or in real-time and for instance may be updated using content from the DBMS 116 or from other network components coupled to the email platform 112. Such updated content may be transmitted to the user application for display on the portion or page of the user application 142 of the individual user as provided herein.

According to such implementation of use, the user application 142 also includes a second plurality of pages (e.g., common channels to which the user is a member), and each of the second of the plurality of pages is associated with an email address different from each other. For instance, where there are three pages in the second plurality of pages, each of the three pages is assigned a unique email address. The user accounts stored on the server of the content provider 110 are also associated with the email addresses of the second plurality of pages so that the second templates delivered and displayed on the second plurality of pages of the registered user applications contain the same content across the plurality of user accounts. For instance, the second plurality of pages and corresponding second templates may be populated with content such as advertising and marketing information applicable to all or a broad range of users of the user application 142. In some implementations, when a registered user account is added to the content provider 110, the user account may be added to a general channel responsible for transmitting the second plurality of pages such that when one or more of the second pages is updated, the content is transmitted to the user applications 142 of the registered user accounts so that every registered user receives the updated content. In some implementations updating the second pages of a single user application may involve each of the second pages receiving an email having a matching email address of the second page such that separate emails are received for updating each of the second pages, e.g., three emails are sent to update three of the second pages. In further implementations, multiple of the second pages of a single user application may be updated using a single email. In this example, an email template may contain HTML content for multiple second pages of the user application, and for instance the CMS 130 may parse the HTML content and transmit the content to a corresponding page or section of the user application 142. For instance, the HTML content may be tagged and used by the CMS 130 for allocation to a corresponding page or portion thereof. In the preceding examples, where the second pages are common channels, each of the user applications of the plurality of users on the network may be updated, thus reducing the volume of data being managed by and sent over the network 100.

In a holiday use case, a holiday newsletter includes three article types: Recipe of the Day; Cocktail of the Day; and Gift Offer of the Day. A single newsletter email can be forwarded into the CMS and the platform will identify the three sections and put them into the appropriate channels where members subscribe, i.e., the Recipes channel, Cocktails channel, and Offers channel, and the corresponding pages of the user application 142 receive parsed content provided by the CMS.

In further implementations of use, the CMS 130 may receive the first and second templates or content from the email platform 112 and transmit them or cause the emails to be transmitted to a corresponding page of the user application 142, where prior to transmitting to the user application 142, the CMS 130 determines a format of a corresponding section of the user application and adjusts the first and second templates or content to the determined format.

The CMS 130 may also be configured to, prior to transmitting to the user application 142, perform various email sanitization steps including one or more of: identifying and removing a signature from the template or content, identifying and removing an unsubscribe link from the template or content; identifying and removing tracking pixels from the template; identifying a table and freezing the table within the template or content; identifying an image and fitting the image within the template or content; and identifying a table and fitting the table to an identified format of the corresponding section of the user application.

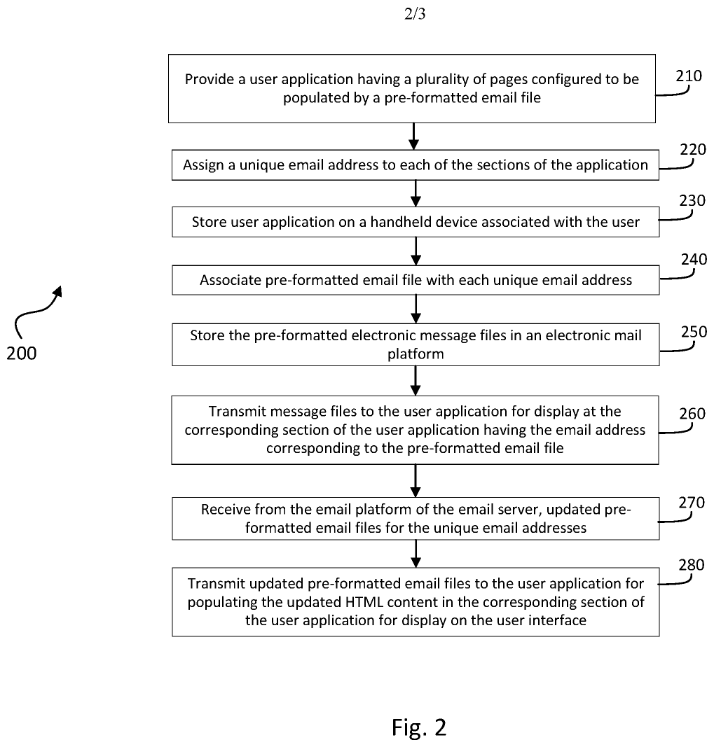

FIG. 2 illustrates a method 200 of administering user applications on handheld devices using an email platform, which may be implemented using the network 100 of FIG. 1, according to the present disclosure. The method 200 may involve establishing or providing a plurality of pages of a user application, e.g., user application 142 (step 210), where each page includes one or more sections configured to be populated by a pre-formatted electronic message, e.g., a HTML email file, where such pre-formatted electronic message is configured to be transmitted over a network, e.g., network 100, and received at a client email server (e.g., incoming mail server 120) ultimately for display on the user application 142. The method 200 continues by assigning a unique email address to each of or to various the sections of the user application (step 220). At least one unique email address of the user application may be specific to a user and associated of a handheld device (e.g., handheld device 140). With the user application stored on the handheld device associated with the user (step 230), when communicatively coupled to an incoming mail server (e.g., incoming email server 130), can receive pre-formatted emails associated with an email platform having a template library, as provided herein. A pre-formatted email file is associated with each unique email address (step 240), and for instance, the pre-formatted email file is configured both as HTML content or a template and to be displayed as pre-formatted content in a section of the user application having the correspondingly assigned unique email address. Where content to be displayed is unique and specific to a user, the pre-formatted email file may be assigned an email address unique to the account of the user, and the content therein may be specific to the user. For example, the pre-formatted email may be populated with information pertaining to the user's account such as the user name, user identification, points, user rewards, and other user-specific information such as user demographics, history, the user's progress to a next tier or level in a loyalty program, points (e.g., comp points or tier points), whether the user has redemptions available (e.g., free slot play, coupons and/or money), whether the user has personalized offers (e.g., hotel stays, entertainment offers, dining credits), and so on. The method 200 may proceed by storing the pre-formatted electronic message files in an email platform, e.g., email platform 112 (step 250). Such message files may then be transmitted to the user application such as via the CMS 30 where the message files are analyzed and/or processed for display in the corresponding section of the user application having the email address corresponding to the pre-formatted email file (step 260) and the CMS 30-processed messaged files may subsequently be displayed on a user interface of the user device as applicable, e.g., on the corresponding page of the user application. As provided herein, one of the pre-formatted electronic message files may be configured to display user account information associated with the user of the application. The method 200 proceeds by receiving from the email platform of the email server, updated HTML email files for the unique email addresses (step 270) where the updated HTML email files contain updated HTML content. The updated HTML email files are transmitted to the user application for populating the updated HTML content in the corresponding section of the user application for display on the user interface (step 280).

Method 200 may be modified by or include other operations disclosed in connection with the present disclosure. For instance, method 200 may involve assigning unique headers (e.g., email headers) instead of unique email address to each user. In this example, the header may allow for more variable application content to be updated on a per user basis in a single email transmission versus multiple individual templates being sent to multiple unique email addresses as provided herein. Assigning headers may enable a reduced volume of data transmission over the network 100, which may improve network efficiency.

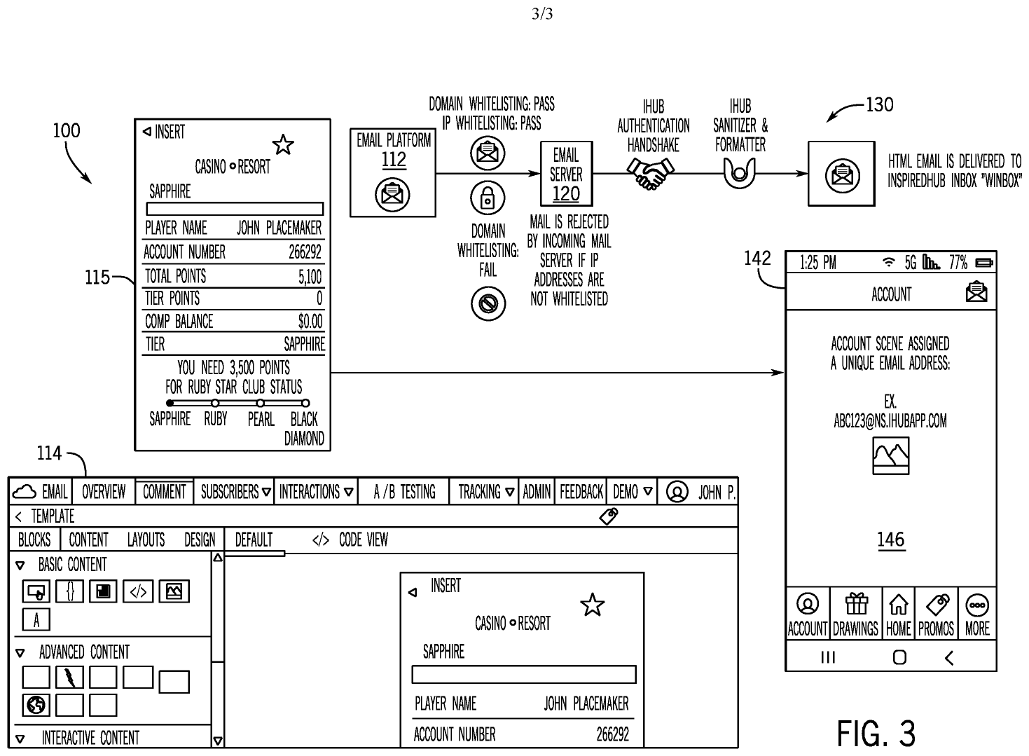

FIG. 3 illustrates certain aspects of the network 100 for administering user applications 142 on handheld devices 140 using the email platform 112, according to the present disclosure. The template library 114 is illustrated in a graphical user interface, which may be provided by the content provider 110. The templates of the template library may be assigned an email address such as “abc123@ns.ihubapp.com” and contain general information such as graphics, logos, formatting tables, and text such as information identifiers such as player name, account number, total points, balance. The templates may be used to generate populated templates 115 for transmission via the email platform 112. Populated templates 115 may be populated with information specific to a user, such as a player name of the user, account number of the user, total points of the user, balance of the user, goal tracking of the user, and so on. The populated templates 115 may be transmitted over the network 100 and processed by the email server 120 and/or the CMS 130 as provided herein, and delivered to a page 146 of the user application 142 having the matching email address “abc123@ns.ihubapp.com”. Because the CMS 130 formats (e.g., sizes) the populated template 115 prior to it reaching the page 146 of the user application 142, the populated template is displayed so that the content fits within the account scene window. The populated template 115 may be delivered to the user application 142 of a specific user 144, e.g., the user having the Player Name John PlaceMaker. While the populated template 115 of FIG. 3 includes content customized to a user 144, it will be appreciated that other populated templates may include content applicable to all account holders such as promotional content, and such populated templates may be delivered to the user applications 142 of all account users, as provided herein.

The reduction of network traffic may be realized by the reduction of the duplication of content by dividing content and pushing the content through opt-in channels. For instance, by splitting a newsletter into channels, one newsletter is segmented into channels that can have thousands of readers via syndication means less traffic; instead of 10,000 emails sent that may not be wanted by readers, there are three posts created into the opt-in channels where users control the notifications. Another way to reduce network traffic is to provide template updates that can be used to inform email but uploaded into the content provider and then a mirror/validation is used when changes are made.

Various functionalities described herein may be accomplished with the use of a computer, including the controller or processor and non-transitory computer readable medium or memory, with instructions stored thereon to be executed by the controller or processor. For instance, a computer-readable storage medium with an executable program stored thereon may instruct the controller or processor to perform the functions provided herein.

From the foregoing description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A computer-implemented method for administering a user application using an email platform, comprising:
providing a user application comprising plurality of pages, each page having one or more sections configured to be populated by a pre-formatted email file, wherein each section is assigned a unique email address;
storing the application on a user device, the application communicatively coupled to an email server comprising an email platform;
associating a pre-formatted email file with each unique email address, the pre-formatted email file configured by a template and configured to be displayed as content in the section of the application having the corresponding assigned unique email address;
storing the HTML email files in the email server;
transmitting the pre-formatted email files to the section of the application having the email address corresponding to the pre-formatted email file;
displaying the transmitted pre-formatted email file on a user interface of the user device;
receiving from the email platform of the email server, updated pre-formatted email files for the unique email addresses, the updated pre-formatted email files containing updated content; and
transmitting the updated pre-formatted email files to the application for populating in the corresponding section of the application for display on the user interface.

2. The method of claim 1, wherein the user device is associated with a user, and wherein the user is assigned a unique user email address, wherein the unique user email address is associated with one of the plurality of pages of the user application, and wherein the pre-formatted email assigned the unique user email address is configured to receive content associated with the user comprising two or more of a user name, a user identification, user statistics, user rewards, and user-specific information.

3. The method of claim 2, wherein another of the plurality of pages of the user application is associated with promotional content, wherein the promotional content is delivered to a plurality of users of a plurality of user applications stored on a plurality of user devices.

4. The method of claim 3, wherein the one of the plurality of pages and the another plurality of pages are each configured as read only pages.

5. A computer-implemented method for administering a user application using an email platform, comprising:
causing a user application to be stored on a user device, the user application comprising a plurality of pages, each page having one or more sections configured to be populated by a pre-formatted email file, wherein each section is assigned a unique email address;
associating a pre-formatted email file with each unique email address of the user application, the pre-formatted email file comprising the unique email address corresponding to a respective section of the user application, and the pre-formatted email file configured as a template and to be displayed as content in the section of the user application having the correspondingly assigned unique email address;
causing the pre-formatted email files to be transmitted to the corresponding section of the application having the email address corresponding to the pre-formatted email file; and
causing the transmitted pre-formatted email file to be displayed on a user interface of the user device.

6. The method of claim 5, wherein the user device is associated with a user, and wherein the user is assigned a unique user email address, wherein the unique user email address is associated with one of the plurality of pages of the user application, and wherein the pre-formatted email assigned the unique user email address is configured to receive content associated with the user comprising two or more of a user name, a user identification, user statistics, user rewards, and user-specific information.

7. The method of claim 5, wherein prior to causing the pre-formatted email files to be transmitted to the corresponding section of the application having the email address corresponding to the pre-formatted email file, the method further comprises determining a format of the corresponding section of the user application; and adjusting the pre-formatted email to the determined format.

8. The method of claim 7, wherein the step of causing the transmitted pre-formatted email file to be displayed on a user interface of the user device, further comprises causing the adjusted pre-formatted email to be displayed on the user interface.

9. The method of claim 5, wherein prior to causing the pre-formatted email files to be transmitted to the corresponding section of the application having the email address corresponding to the pre-formatted email file, the method comprises evaluating the pre-formatted email file using a content management system, wherein evaluating comprises two or more of:
a. identifying and removing a signature with the pre-formatted email file;
b. identifying and removing an unsubscribe link from the pre-formatted email file;
c. identifying and removing tracking pixels from the pre-formatted email file;
d. identifying a table and freezing the table within the pre-formatted email file;
e. identifying an image and fitting the image within the template or content; and
f. identifying a table and fitting the table to an identified format of the corresponding section of the user application.

10. The method of claim 5, wherein prior to causing the pre-formatted email files to be transmitted to the corresponding section of the application having the email address corresponding to the pre-formatted email file, the method comprises evaluating the pre-formatted email file using a content management system, wherein evaluating comprises determining a domain from which the pre-formatted email file was transmitted is contained in an approved sender list.

11. The method of claim 5, wherein the user application is a progressive web application (PWA) or a native application.

12. The method of claim 11, wherein the user application is a read only application.

13. The method of claim 5, wherein the pre-formatted email file is a HTML email file.

14. The method of claim 5, further comprising:
causing updated pre-formatted email files to be received at the user device, the updated pre-formatted email files containing updated content; and
causing the updated pre-formatted email files to be displayed on a user interface of the user device.

15. A system for administering user applications installed on handheld devices registered to a plurality of users using an email platform, the system comprising:
a server storing a plurality of user accounts, each user account associated with a registered user application of the user applications and an email address unique to each user account,
wherein each email address unique to each user account is associated with a first page of a plurality of pages of the registered user application and is associated with a first template configured for delivery by an email platform to the first page of the user application of the registered user application such that first templates configured for delivery by the email platform to the first pages of the registered user applications contain different content across the plurality of user accounts,
wherein the user application comprises a second plurality of pages, and wherein the second plurality of pages of the user application are each associated with an email address that is different from each other, and
wherein the registered user applications of the plurality of user accounts each include the same second plurality of pages of the user application having the same associated email addresses such that second templates configured for delivery by the email platform to the second plurality of pages of the registered user applications contain the same content across the plurality of user accounts.

16. The system of claim 15, further comprising a content management system configured to receive the first and second templates configured for delivery by the email platform and to transmit the first and second templates to a corresponding page of the user application as templated content, wherein prior to transmitting to the user application, the content management system determines a format of a corresponding section of the user application and adjusts the templated content to the determined format.

17. The system of claim 15, further comprising a content management system configured to receive the first and second templates configured for delivery by the email platform and to transmit the first and second templates to a corresponding page of the user application as templated content, wherein prior to transmitting to the user application, the content management system performs two or more of the steps of:
a. identifying and removing a signature with the pre-formatted email file;
b. identifying and removing an unsubscribe link from the pre-formatted email file;
c. identifying and removing tracking pixels from the pre-formatted email file;
d. identifying a table and freezing the table within the pre-formatted email file;
e. identifying an image and fitting the image within the template or content; and
f. identifying a table and fitting the table to an identified format of the corresponding section of the user application.
